(19) United States
(12) Patent Application Publication
(10) Pub. No.: US 2021/0218339 A1
(43) Pub. Date: Jul. 15, 2021

(54) POWER CONVERSION DEVICE

(71) Applicant: DENSO CORPORATION, Kariya-city (JP)

(72) Inventor: Shizuo TSUCHIYA, Kariya-city (JP)

(21) Appl. No.: 17/215,366

(22) Filed: Mar. 29, 2021

Related U.S. Application Data
(63) Continuation of application No. PCT/JP2019/034805, filed on Sep. 4, 2019.

(30) Foreign Application Priority Data
Oct. 4, 2018 (JP) 2018-189341

(51) Int. Cl. H02M 3/335; H02J 7/00; H02J 7/35; H02J 3/38

(52) U.S. Cl. CPC H02M 3/33569; H02J 7/0068; H02J 2300/24; H02J 3/381; H02J 7/35

(57) ABSTRACT

A power conversion device includes a DC load, a solar cell, a storage battery, a first converter circuit for the DC load, a second converter circuit for the solar cell, a third converter circuit for the storage battery, a system power supply, and a controller. Each of the first to third converter circuits has a switching element and a reactor. The reactors of the first to third converter circuits are connected to each other at a connection point in a form of star connection. The controller controls the switching elements of the first to third converter circuits. The controller controls the voltage at the connection point so as to enable at least: an electric power supply from the solar cell to the DC load; an electric power supply from the solar cell to the storage battery; and an electric power supply from the storage battery to the DC load.

### CROSS REFERENCE TO RELATED APPLICATIONS

The present application is a continuation application of International Patent Application No. PCT/JP2019/034805 filed on Sep. 4, 2019, which designated the U.S. and claims the benefit of priority from Japanese Patent Application No. 2018-189341 filed on Oct. 4, 2018. The entire disclosures of all of the above applications are incorporated herein by reference.

### TECHNICAL FIELD

The present disclosure relates to a power conversion device.

### BACKGROUND

For example, an electric power supply system includes a power system that supplies AC power, a storage battery using direct current, a photovoltaic power generation device (solar cell 9 using direct current, and a load. Such an electric power supply system is, for example, described in Patent Literatures 1 to 3 listed below, and the contents of the Patent Literatures 1 to 3 can be incorporated herein by reference as explanation of technical elements in this specification.

Patent Literature 1: JP 2012-175792 A

Patent Literature 2: JP 2014-230455 A

Patent Literature 3: JP 2015-195674 A

### SUMMARY

The present disclosure describes a power conversion device including a DC load, a solar cell, a storage battery, a first converter circuit for the DC load, a second converter circuit for the solar cell, a third converter circuit for the storage battery, a system power supply, and a controller. Each of the first to third converter circuits has a switching element and a reactor. The reactors of the first to third converter circuits are connected to each other at a connection point in a form of star connection. The controller controls the switching elements of the first to third converter circuits. The controller controls the voltage at the connection point so as to enable at least: an electric power supply from the solar cell to the DC load; an electric power supply from the solar cell to the storage battery; and an electric power supply from the storage battery to the DC load.

### BRIEF DESCRIPTION OF DRAWINGS

Features and advantages of the present disclosure will become more apparent from the following detailed description made with reference to the accompanying drawings, in which:

FIG. 1 is a block diagram of a power conversion device according to a first embodiment;

FIG. 2 is a functional block diagram showing functions provided by a control device;

FIG. 3 is a list diagram showing operation modes of the power conversion device;

FIG. 4 is a graph showing current-voltage output characteristics;

FIG. 5 is a waveform diagram showing waveforms at the time of switching a control mode; and

FIG. 6 is a flowchart at the time of switching the control mode.

### DETAILED DESCRIPTION

In a power conversion device for a power supply system, it may be necessary to link a load which is supplied with an electric power from a power system with a solar cell and a storage battery. In such a configuration, however, power loss in accordance with power conversion and control complexity are likely to occur. There is demand for further improvement to a power conversion device.

According to an aspect of the present disclosure, a power conversion device includes: a DC load; a solar cell that converts light into electric power; a storage battery that stores and discharges electric power; a first converter circuit that is provided for the DC load and includes at least one switching element and a reactor; a second converter circuit that is provided for the solar cell and includes at least one switching element and a reactor; a third converter circuit that is provided for the storage battery and includes at least one switching element and a reactor; a system power supply that rectifies AC power supplied from a power system to DC power and supplies the rectified DC power between the DC load and the first converter circuit; and a controller controlling the plurality of switching elements. The plurality of reactors are connected to each other at a connection point in the form of star connection, and the controller controls a voltage at the connection point to enable at least (i) an electric power supply from the solar cell to the DC load, (ii) an electric power supply from the solar cell to the storage battery, and (iii) an electric power supply from the storage cell to the DC load.

In the power conversion device according to the above aspect, the plurality of reactors are connected to each other at the connection point in the form of star connection. The controller controls the first converter circuit, the second converter circuit, and the third converter circuit. The controller enables (i) the electric power supply from the solar cell to the DC load. The controller enables (ii) the electric power supply from the solar cell to the storage battery. The controller enables (iii) the electric power supply from the storage battery to the DC load. As a result, power conversion between the plural DC devices including the DC load, the solar cell, the storage battery, and the system power supply becomes possible.

Hereinafter, multiple embodiments will be described with reference to the drawings. In some embodiments, parts which are functionally and/or structurally corresponding and/or associated are given the same reference numerals, or reference numerals with different hundreds digit or higher digits. For corresponding parts and/or associated elements, it is possible to make reference to the description of other embodiments.

### First Embodiment

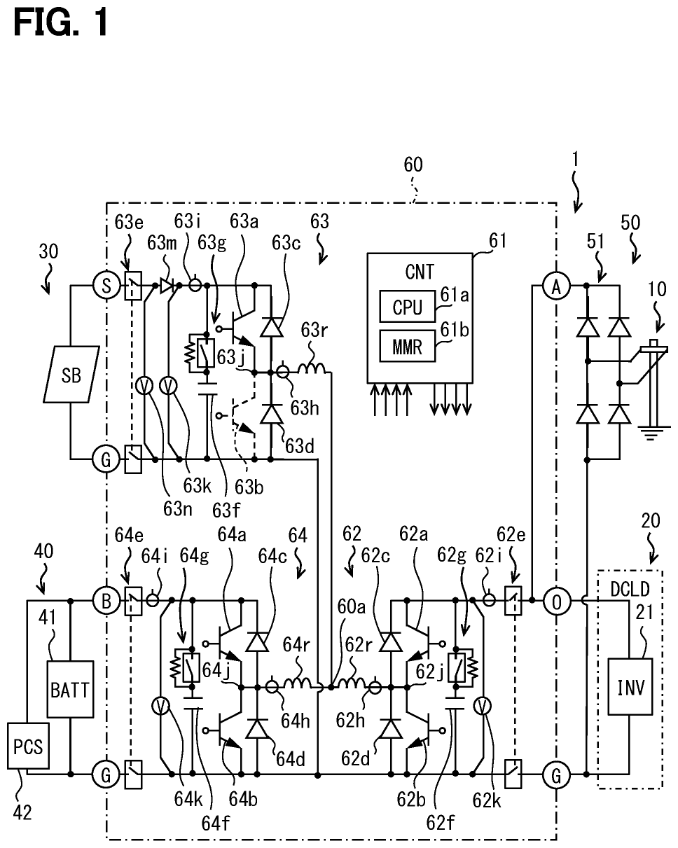

Referring to FIG. 1, an electric power system 1 is installed in a general household or a demand facility including a business establishment. The electric power system 1 is supplied with electric power from a power system 10 that supplies AC (alternating current) power. In general, the power system 10 is provided by so-called commercial power, such as a power grid. Alternatively, the power system 10 may be provided by a private power plant in the demand facility.

(Circuit)

The electric power system 1 has a direct current (DC) load (DCLD) 20. The DC load 20 is the main load of the electric power system 1. The DC load 20 is a load that functions by being supplied with DC power. The DC load 20 is, for example, a water heater. The DC load 20 is, for example, a hot water storage type water heater. The water heater includes, for example, a heat source and a hot water supply facility. The heat source can be provided by an electric heater or a vapor compression heat pump. The vapor compression type heat pump can be provided by, for example, a heat pump that utilizes a natural refrigerant (e.g., carbon dioxide). The DC load 20 includes at least an inverter (INV) 21. The inverter 21 converts the DC power into an AC power. The DC load 20 has an electric motor powered by the inverter 21. The electric motor drives a compressor of the heat pump. The input voltage of the DC load 20 is rated at 288 V±10%.

The DC load 20 executes a hot water supply operation by a command from a user or by a timer command in a preset time zone. During the hot water supply operation, electric power is consumed to boil the hot water used or stored. The DC load 20 functions by an electric power supplied from at least one of a solar cell, a storage battery, and a system power supply. The DC load 20 uses the system power supply in a time zone during which the electric power from the power system 10 can be used under favorable conditions, for example. Further, the DC load 20 uses the electric power of the solar cell or the storage battery when the electric power of the solar cell or the storage battery can be used.

The electric power system 1 has a solar cell (SB) 30. The solar cell 30 converts the energy of light into DC power and outputs the DC power. The solar cell 30 is also called a DC power generation device. The solar cell 30 is also called a natural energy power generation device. The power generation output of the solar cell 30 varies depending on the intensity of sunlight. The power generation output of the solar cell 30 varies in the range of 70 V to 350 V.

The electric power system 1 has a storage battery 40. The storage battery 40 stores electric power and discharges the electric power. The storage battery 40 is charged by the surplus of electric power supplied from the power system 10 or the surplus of the power generation output of the solar cell 30. The storage battery 40 discharges the stored electric power to be supplied to the DC load 20. The storage battery 40 includes a stationary main battery 41. The storage battery 40 may include a removable auxiliary battery. The storage battery 40 has a power conditioner (PCS) 42 for the auxiliary battery. The auxiliary battery can be provided by a traveling battery mounted on a hybrid vehicle or an electric vehicle. The main battery 41 and/or the auxiliary battery can be provided by various batteries such as a lithium ion battery and a nickel cadmium battery. In a case where the auxiliary battery is a lithium ion battery, the power conditioner 42 is provided by a bidirectional power conditioner for the lithium ion battery. The electric power system 1 may include only the main battery 41.

The electric power system 1 has a system power supply 50. The system power supply 50 has a full-wave rectifier 51. The full-wave rectifier 51 converts the input alternating current into direct current and outputs the direct current. The full-wave rectifier 51 is provided by a diode bridge circuit. The full-wave rectifier 51 may be provided by an inverter including a plurality of switching elements. The switching element is hereinafter referred to as a SW element. The full-wave rectifier 51 is a two-phase full-wave rectifier. The full-wave rectifier 51 is provided by, for example, a three-phase full-wave rectifier when the power system 10 supplies a three-phase alternating current. The SW element can be provided by various elements such as a diode, a transistor, a MOSFET, an IGBT (insulated gate bipolar transistor), and a thyristor. The power system 10 and the full-wave rectifier 51 provide a system power supply 50 to which the electric power is supplied from the power system 10, such as a power grid. The system power supply 50 provides the main power supply in the electric power system 1.

In the present embodiment, the solar cell 30 also supplies DC power. However, the solar cell 30 is not the main power supply, but an auxiliary power supply. The power supplied by the system power supply 50 is more stable than the power supplied by the auxiliary power supply.

The electric power system 1 has a power conversion device 60. The power conversion device 60 is also referred to as a multi-DC-DC converter. The power conversion device 60 controls the DC power flowing between the multiple DC devices. The multiple DC devices include at least the DC load 20 and the system power supply 50. The multiple DC devices may include at least the solar cell 30 or the storage battery 40. The multiple DC devices may include at least the DC load 20, the system power supply 50, the solar cell 30, and the storage battery 40. The power conversion device 60 includes multiple ground terminals G, a system power supply terminal A, an output terminal O, a solar cell terminal S, and a storage battery terminal B. The DC load 20 is connected between the output terminal O and the ground terminal G. The solar cell 30 is connected between the solar cell terminal S and the ground terminal G. The storage battery 40 is connected between the storage battery terminal B and the ground terminal G. The full-wave rectifier 51, that is, the system power supply 50 is connected between the system power supply terminal A and the ground terminal G.

The power conversion device 60 includes a controller (CNT) 61. The controller 61 provides a control system for controlling the power conversion device 60. The controller 61 includes a central processing unit (CPU) 61a and a memory (MMR) 61b. The controller 61 receives detection signals from a plurality of sensors, which will be described later, and controls a plurality of switching elements which are a plurality of control targets to be controlled.

The controller in this specification is an electronic control unit (ECU). The controller may also be referred to as a computer or microcomputer. The controller provides a control system for controlling a control target. At least one function in this specification is provided by at least one controller configured to provide that function. The term “at least one controller configured to provide the function” may be provided by (1) software recorded on a storage medium and hardware executing the software, (2) software only, or (3) hardware only. For example, the controller can be provided by a logic called if-then-else type or a neural network tuned by machine learning.

An example of the controller is a computer that includes at least a memory that stores the program and at least one processor that executes the program. In this case, the processor may also be referred to as a central processing unit (CPU), a graphics processing unit (GPU), or the like. The memory may also be referred to as a storage medium. The memory is a non-transitory and tangible storage medium, which non-temporarily stores a program and/or data readable by the processor. The storage medium may be a semiconductor memory, a magnetic disk, an optical disk, or the like. The program includes multiple computer instructions. By being executed by the processor, the program causes the processor to function as a device described herein and to perform the method described herein. The program may be distributed as a single article or as a storage medium in which the program is stored.

An example of the controller is a computer including a digital circuit having a large number of logic units or a processor including an analog circuit. In this case, the processor may also be referred to as a programmable gate array (PGA), a field programmable gate array (FPGA), a complex programmable logical device (CPLD), or the like. The processor may include a memory in which “programs and/or data” is stored.

At least one function in this specification is provided by at least one processor configured to provide that function. The term “at least one processor configured to provide the function” may include multiple processors linked by a data communication device. The term “at least one processor configured to provide a function” includes: (1) a configuration in which the function is achieved by software; (2) a configuration in which the function is achieved by hardware; and (3) a configuration in which the function is achieved by both software and hardware.

The controller, the signal source, and the control target object provide various elements. At least part of such elements may be referred to as a block for performing a function. In another aspect, at least a part of those elements may be referred to as sections or sections that are interpreted as a configuration. Furthermore, only in a case intended, such elements included in the control system may be referred to as means for performing the functions thereof.

The power conversion device 60 includes a first converter circuit 62, a second converter circuit 63, and a third converter circuit 64 in order to enable power conversion between the multiple DC devices 20, 30, 40, and 50. The multiple converter circuits are hereinafter referred to as the DCCs. The DCC may also be referred to as a DC/DC converter circuit or a chopper circuit. The multiple DC devices 20, 30, 40, and 50 include at least the DC load 20, the solar cell 30, the storage battery 40, and the system power supply 50. The DC load 20 is directly connected to the system power supply 50.

The DCC 62 includes a SW element 62a that provides an upper arm and a SW element 62b that provides a lower arm. The SW element 62a and the SW element 62b are connected in series. The SW element 62a and the SW element 62b are controlled by the controller 61. The DCC 62 has a diode 62c connected in antiparallel to the SW element 62a. The DCC 62 has a diode 62d connected in antiparallel to the SW element 62b. The SW element 62a, the SW element 62b, the diode 62c, and the diode 62d are packaged as a unit that provides an upper arm and a lower arm.

The DCC 62 has cutout relays 62e between the terminals O and G and the circuit. The cutout relays 62e can disconnect a positive side circuit and a negative side circuit. The cutout relay 62e is shown as in an open state. However, when the power conversion device 60 functions, the cutout relay 62 is in a closed state. The cutout relay 62e is controlled by the controller 61.

The DCC 62 has a smoothing capacitor 62f. The DCC 62 has a discharge circuit 62g. The discharge circuit 62g is arranged in series with the smoothing capacitor 62f. The discharge circuit 62g is a parallel circuit of a discharge resistor and a relay. The discharge circuit 62g suppresses excessive charge accumulation by discharging electric charges of the smoothing capacitor 62f through the discharge resistor. The discharge circuit 62g is shown as in an open state. However, when the power conversion device 60 functions, the discharge circuit 62g is in a closed state.

The DCC 62 has a reactor 62r. The reactor 62r is arranged between the connection point 62j between the SW element 62a and the SW element 62b and the connection point 60a. The DCC 62 provides a buck-boost converter circuit capable of performing both a stepping-up operation and a stepping-down operation.

The DCC 62 has insulated-type DC current sensors 62h and 62i. The current sensor 62h is arranged between the reactor 62r and the connection point 62j. The current sensor 62i is arranged between the cutout relay 62e and the circuit.

The DCC 62 has an insulated-type DC voltage sensor 62k. The voltage sensor 62k is arranged in parallel with the smoothing capacitor 62f. The voltage sensor 62k detects the voltage across the smoothing capacitor 62f.

The DCC 63 includes a SW element 63a that provides an upper arm and a SW element 63b that provides a lower arm. The SW element 63a and the SW element 63b are connected in series. The SW element 63a and the SW element 63b are controlled by the controller 61. The DCC 63 has a diode 63c connected in antiparallel to the SW element 63a. The DCC 63 has a diode 63d connected in antiparallel to the SW element 63b. The SW element 63a, the SW element 63b, the diode 63c, and the diode 63d are packaged as a unit that provides an upper arm and a lower arm. In the present embodiment, the SW element 63b is not used. Therefore, the SW element 63b is shown by a broken line in FIG. 1.

The DCC 63 has cutout relays 63e between the terminals S and G and the circuit. The cutout relays 63e can disconnect a positive side circuit and a negative side circuit. The cutout relay 63e is shown as in an open state. However, when the power conversion device 60 functions, the cutout relay 63e is in a closed state. The cutout relay 63e is controlled by the controller 61.

The DCC 63 has a smoothing capacitor 63f. The DCC 63 has a discharge circuit 63g. The discharge circuit 63g is arranged in series with the smoothing capacitor 63f. The discharge circuit 63g is a parallel circuit of a discharge resistor and a relay. The discharge circuit 63g suppresses excessive charge accumulation by discharging electric charges of the smoothing capacitor 63f through a discharge resistor. The discharge circuit 63g is shown as in an open state. However, when the power conversion device 60 functions, the discharge circuit 63g is in a closed state.

The DCC 63 has a reactor 63r. The reactor 63r is arranged between the connection point 63j between the SW element 63a and the SW element 63b and the connection point 60a. The DCC 63 provides a buck converter circuit capable of performing a stepping-down operation only.

The DCC 63 has insulated-type DC current sensors 63h and 63i. The current sensor 63h is arranged between the reactor 63r and the connection point 63j. The current sensor 63i is arranged between the cutout relay 63e and the circuit.

The DCC 63 has an insulated DC voltage sensor 63k. The voltage sensor 63k is arranged in parallel with the smoothing capacitor 63f. The voltage sensor 63k detects the voltage across the smoothing capacitor 63f.

The DCC 63 has a diode 63m that prevents a backflow from the circuit to the solar cell 30. The diode 63m is arranged between the circuit and the solar cell 30. The DCC 63 has an insulated DC voltage sensor 63n. The voltage sensor 63n is arranged in parallel with the solar cell 30. The voltage sensor 63n detects the voltage on the anode side of the diode 63m. Since the voltage sensor 63k detects the voltage of the smoothing capacitor 63f, the voltage of the solar cell 30 may not be detected accurately. The voltage sensor 63n accurately detects the voltage of the solar cell 30. In the maximum power point tracking control (MPPTC) for maximizing the amount of power generation of the solar cell 30, the output of the voltage sensor 63n is used. As a result, the accurate MPPTC is realized.

The DCC 64 includes a SW element 64a that provides an upper arm and a SW element 64b that provides a lower arm. The SW element 64a and the SW element 64b are connected in series. The SW element 64a and the SW element 64b are controlled by the controller 61. The DCC 64 has a diode 64c connected in antiparallel to the SW element 64a. The DCC 64 has a diode 64d connected in antiparallel to the SW element 64b. The SW element 64a, SW element 64b, diode 64c, and diode 64d are packaged as a unit that provides an upper arm and a lower arm.

The DCC 64 has cutout relays 64e between the terminals B and G and the circuit. The cutoff relays 64e can disconnect a positive side circuit and a negative side circuit. The cutout relay 64e is shown as in an open state in FIG. 1. However, when the power conversion device 60 functions, the cutout relay 64e is in a closed state. The cutout relay 64e is controlled by the controller 61.

The DCC 64 has a smoothing capacitor 64f. The DCC 64 has a discharge circuit 64g. The discharge circuit 64g is arranged in series with the smoothing capacitor 64f. The discharge circuit 64g is a parallel circuit of a discharge resistor and a relay. The discharge circuit 64g suppresses excessive charge accumulation by discharging electric charges of the smoothing capacitor 64f through the discharge resistor. The discharge circuit 64g is shown as in an open state in FIG. 1. However, when the power conversion device 60 functions, the discharge circuit 64g is in a closed state.

The DCC 64 has a reactor 64r. The reactor 64r is arranged between the connection point 64j between the SW element 64a and the SW element 64b and the connection point 60a. The DCC 64 provides a buck-boost converter circuit capable of performing both a stepping-up operation and a stepping-down operation.

The DCC 64 has insulated DC current sensors 64h and 64i. The current sensor 64h is arranged between the reactor 64r and the connection point 64j. The current sensor 64i is arranged between the cutout relay 64e and the circuit.

The DCC 64 has an insulated DC voltage sensor 64k. The voltage sensor 64k is arranged in parallel with the smoothing capacitor 64f. The voltage sensor 64k detects the voltage across the smoothing capacitor 64f.

The plurality of DCCs 62, 63, and 64 are directly connected to each other. The plurality of DCCs 62, 63 and 64 are connected to each other by connecting the multiple reactors 62r, 63r and 64r in the form of star-connection (Y connection). In the illustrated embodiment, the three reactors 62r, 63r, and 64r are three-phase connected. The three reactors 62r, 63r and 64r are electrically connected to each other at the connection point 60a. The system power supply 50 rectifies the AC power supplied from the power system 10 into DC power. The system power supply 50 supplies the rectified DC power to a node between the DC load 20 and the DCC 62.

(Control)

The controller 61 provides a determination unit that determines a control mode based on an operation state. The controller 61 provides multiple mode units that control elements of the multiple DCCs 62, 63 and 64 of the power conversion device 60 so as to realize the control mode determined by the determination unit. The multiple mode units cause the multiple DCCs 62, 63 and 64 to perform the stepping-up operation of the stepping-down operation. As a result, the multiple mode units realize the multiple control modes. The controller 61 mainly performs a pulse width modulation (PWM) control of the multiple SW elements 62a, 62b, 63a, 64a, and 64b.

The controller 61 controls the voltage at the connection point 60a so as to enable at least: (1) an electric power supply from the solar cell 30 to the DC load 20; (2) an electric power supply from the solar cell 30 to the storage battery 40; and (3) an electric power supply from the storage battery 40 to the DC load 20. Further, the controller 61 controls the voltage at the connection point 60a so as to enable (4) an electric power supply from the system power supply 50 to the storage battery 40.

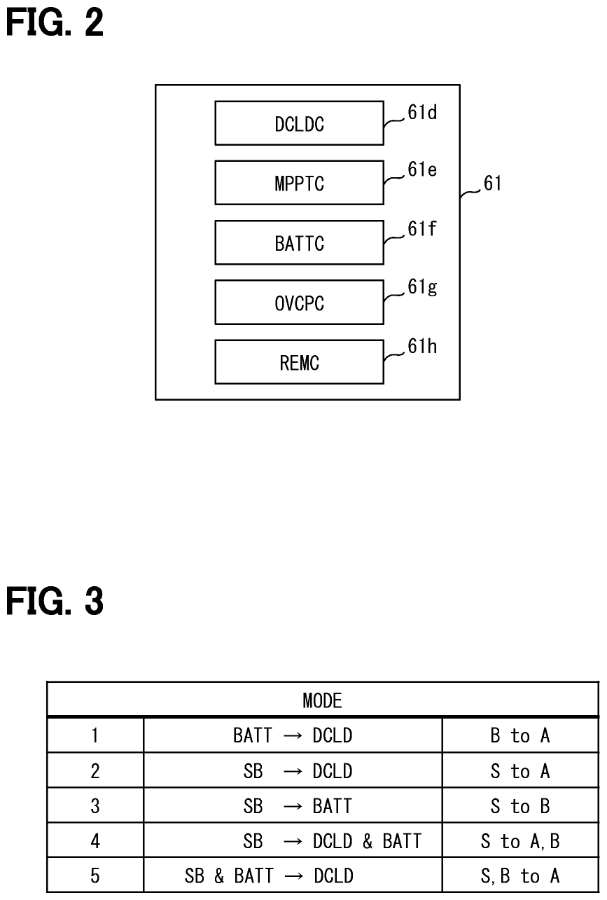

FIG. 2 shows a functional block provided by the controller 61. The controller 61 controls the power conversion device 60 as a direct current load control unit (DCLDC) 61d. The controller 61 PWM-controls the SW element 62a so that the DCC 62 steps down the output from the DC load 20 (system power supply 50). The DC load control unit 61d controls the SW element 62a as a stepping-down SW element. In this case, the DC load control unit 61d functions to supply (that is, to charge) electric power from the system power supply 50 to the storage battery 40. The controller 61 PWM-controls the SW element 62b so that the DCC 62 steps up the input to the DC load 20. The DC load control unit 61d controls the SW element 62b as a stepping-up SW element. In this case, the DC load control unit 61d functions to supply electric power from the solar cell 30 or the storage battery 40 to the DC load 20. In the present embodiment, reverse power flow to the power system 10 is not performed.

The controller 61 controls the DCC 62 so as to execute the maximum power point tracking control of the solar cell 30. The controller 61 controls the power conversion device 60 as the maximum power point tracking control unit (MPPTC) 61e. The controller 61 PWM-controls the SW element 63a for the MPPTC. The controller 61 controls the DCC 63 to perform the stepping-down operation for the MPPTC.

The controller 61 controls the power conversion device 60 as a storage battery control unit (BATTC) 61f. The controller 61 PWM-controls the SW element 64a so that the DCC 64 steps down the output from the storage battery 40. The storage battery control unit 61f controls the SW element 64a as a stepping-down SW element. The controller 61 PWM-controls the SW element 64b so that the DCC 64 steps up the input to the storage battery 40. The storage battery control unit 61f controls the SW element 64b as a stepping-down SW element.

The storage battery control unit 61f includes a feedback system that feedback-controls the SW elements 64a and 64b of the DCC 64. The storage battery control unit 61f functions in response to a sudden change that includes a sudden decrease in the amount of power generated by the solar cell 30 and a sudden change in the DC load 20. The storage battery control unit 61f sets the gain of the feedback system to a reinforcement gain that is larger than a predetermined value for a predetermined period of time from the sudden change. After the predetermined period of time elapses, the storage battery control unit 61f returns the gain of the feedback system to a gain smaller than the reinforcement gain.

The reinforcement gain is set until the current of the storage battery 40 reaches a predetermined current value, after the sudden change. In other words, the reinforcement gain is kept until the charging current and/or discharge current of the storage battery 40, which has fluctuated after the sudden change, becomes stable again. Thereby, the period of time can be set according to the behavior of the current of the storage battery 40.

After the predetermined period of time elapses, the storage battery control unit 61f returns the gain of the feedback system from the reinforcement gain to the gain of the steady state. The gain of the steady state is a value for the feedback system to function stably. As a result, both responsiveness and stability of the feedback system can be achieved. The reinforcement gain enhances the charge/discharge responsiveness of the storage battery 40 and improves the rising of the current of the storage battery 40. The ratio of the steady state gain to the reinforcement gain (i.e., steady state gain/reinforcement gain) is set to about 10.

The storage battery control unit 61f functions while defining the current flowing through the solar cell 30 as a power generation current value, the current flowing through the storage battery 40 as a storage battery current value, and the current required to be supplied to the DC load 20 as a load current command value. The storage battery control unit 61f feedback-controls the storage battery current value so as to satisfy the relationship of “load current command value+power generation current value+storage battery current value=0” at the connection point 60a.

The controller 61 controls the power conversion device 60 as an overvoltage prevention control unit (OVCPC) 61g. The overvoltage prevention control unit 61g functions when both the voltage of the solar cell 30 and the voltage of the storage battery 40 are higher than the voltage of the DC load 20 (voltage of the system power supply 50) and the electric power is supplied from the solar cell 30 to the storage battery 40. The overvoltage prevention control unit 61g closes the discharge circuit of the smoothing capacitor 62f in order to prevent overvoltage due to charging of the smoothing capacitor 62f of the DCC 62. At this time, the controller 61 operates the SW element 62a. The overvoltage prevention control unit 61g periodically closes the stepping-down SW element 62a with a pulse width determined by the voltage of the smoothing capacitor 62f. As a result, the discharge circuit including the smoothing capacitor 62f is formed.

The controller 61 controls the power conversion device 60 as a remaining control unit (REMC) 61h. The remaining control unit 61h provides various functions, which will be described later.

The controller 61 controls, when the DC load 20 requires the electric power, the multiple DCCs 62, 63 and 64 so that the electric power is supplied to the DC load 20 from the solar cell 30, the storage battery 40, or the system power supply 50. When the generated power of the solar cell 30 is at an available level, the controller 61 controls the multiple DCCs 62, 63, and 64 so as to supply the generated power of the solar cell 30 to the DC load 20. When the electric power of the storage battery 40 is at an available level, the controller 61 controls the multiple DCCs 62, 63, and 64 so as to supply the electric power of the storage battery 40 to the DC load 20. When the power generated by the solar cell 30 is at an available level and the DC load 20 does not require the electric power, the controller 61 controls the multiple DCCs 62, 63, and 64 so as to supply the generated power of the solar cell 30 to the storage battery 40 and charge the storage battery 40. The storage battery 40 may be supplied and charged with the electric power from the system power supply 50.

The controller 61 controls the multiple SW elements so that the voltage at the connection point 60a becomes the lowest one of the voltage of the solar cell 30 and the voltage of the storage battery 40, or the voltage corresponding to the lowest one plus the voltage drop in the diode.

As illustrated in FIG. 3, the electric power system 1 provides the multiple modes. In all the modes, the system power supply 50 can supply the electric power to the DC load 20. In a first mode, the electric power is supplied from the storage battery 40 to the DC load 20. In a second mode, the electric power is supplied from the solar cell 30 to the DC load 20. In a third mode, the electric power is supplied from the solar cell 30 to the storage battery 40. In a fourth mode, the DC load 20 does not require the electric power from the solar cell 30 or the storage battery 40. In the fourth mode, the electric power is supplied from the solar cell 30 to the DC load 20 and the storage battery 40. In a fifth mode, the electric power is supplied from the solar cell 30 and the storage battery 40 to the DC load 20.

(1) Electric Power Supply to DC Load 20

There may be a case where the generated power voltage of the solar cell 30 (for example, 320 V) and the voltage of the storage battery 40 are higher than the voltage of the DC load 20 (for example, 288V). In this case, the controller 61 causes the DCCs 63 and 64 to perform the stepping-down operation. The first mode is performed in a case where the storage battery 40 has a large amount of electricity stored. Therefore, the generated power of the solar cell 30 and/or the surplus power stored previously in the storage battery 40 can be supplied to the DC load 20.

There may be a case where the generated power voltage of the solar cell 30 (for example, 320V) is higher than the voltage of the DC load 20 (for example, 288V) and the voltage of the storage battery 40 (for example, 250V) is lower than the voltage of the DC load 20. In this case, the controller 61 causes the DCC 63 to perform the stepping-down operation and the DCC 64 to perform the stepping-up operation. Further, the controller 61 causes the DCC 62 to perform the stepping-up operation. As a result, although the charging current to the storage battery 40 does not occur, but the electric power can be supplied to the DC load 20.

There may be a case where the voltage of the storage battery 40 is higher than the voltage of the DC load 20 (for example, 288V) and the generated power voltage of the solar cell 30 is lower than the voltage of the DC load 20. In this case, the controller 61 causes the DCC 64 to perform the stepping-down operation and the DCC 62 to perform the stepping-up operation. As a result, the electric power can be supplied to the DC load 20 by the discharging of the storage battery 40.

(2) Charging to Storage Battery 40

There may be a case where the voltage of the DC load 20 is higher than the generated power voltage of the solar cell 30 and the voltage of the DC load 20 is higher than the voltage of the storage battery 40. In this case, the DC load 20 does not consume power. In this case, the controller 61 causes the DCC 63 to perform the stepping-down operation. The controller 61 causes the DCC 63 to perform the stepping-down operation so that the voltage at the connection point 60a becomes lower than the voltage of the DC load 20 (for example, 288 V). As a result, the generated power of the solar cell 30 can be charged to the storage battery 40.

There may be a case where the voltage of the storage battery 40 is higher than the voltage of the DC load 20 and the generated power voltage of the solar cell 30 is higher than the voltage of the DC load 20. In this case, the controller 61 causes the DCC 63 to perform the stepping-down operation, the DCC 64 to perform the stepping-up operation, and the DCC 62 to perform the stepping-down operation. When the SW element (stepping-up transistor) 64b of the DCC 64 or the SW element (stepping-up transistor) 62b of the DCC 62 is turned on, the voltage at the connection point 60a is theoretically half the generated power voltage of the solar cell 30. In many cases, the voltage at the connection point 60a is smaller than the voltage at the DC load 20 (for example, 288 V). Subsequently, when the SW element (stepping-up transistor) 64b, 62b is turned off, the current flows to the storage battery 40 or the DC load 20. However, when the current to the DC load 20 is zero, the voltage at the connection point 60a becomes higher than that of the storage battery 40 due to the stepping-up charging to the storage battery 40. As a result, the smoothing capacitor 62f of the DC load 20 is charged, and the capacitor voltage becomes high. In this case, the SW element 62a (stepping-down transistor) of the DCC 62 is turned on, and the discharge control for discharging the smoothing capacitor 62f is executed. In this case, the signal for controlling the SW element 62a is generated by calculation from the voltage of the smoothing capacitor 62f, that is, the voltage of the DC load 20. Maps can be used for the calculation. In this way, the generated power of the solar cell 30 can be charged to the storage battery 40.

(3) Voltage Control of Connection Point 60a

In the power conversion device 60, if the output response of any of the multiple DCCs 62, 63, and 64 is slow, a situation may occur in which the voltage of the DC load 20 drops and falls below the minimum operating voltage of any of the DC devices. In such a situation, the power conversion device 60 may be stopped due to the protection function executed by the controller 61. For example, the cutout relays 62e, 63e, 64e disconnect the circuits to stop the system. In order to suppress such a situation, the controller 61 employs the following control logic.

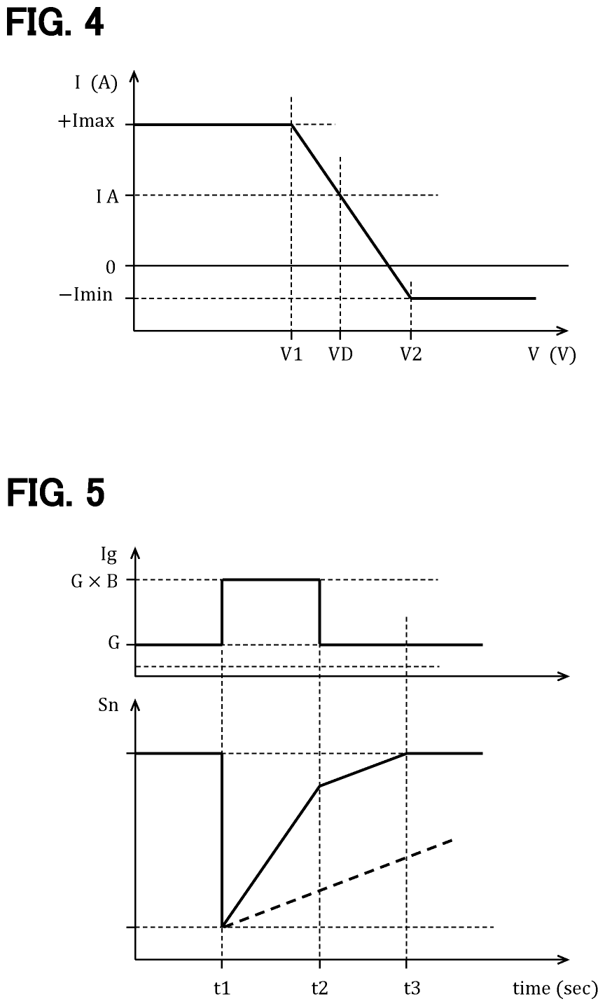

The controller 61 calculates the load current command value I from the voltage V of the DC load 20 based on the voltage/current output characteristic of FIG. 4. FIG. 4 shows a conversion characteristic for obtaining the load current command value I according to the voltage V of the DC load 20. When the voltage V is lower than V1, the load current command value I is set to the maximum value Imax. When the voltage V is higher than V2, the load current command value I is set to the minimum value Imin. When the voltage V is in the range from the voltage V1 to the voltage V2, the load current command value I reduces with the increase in the voltage V. For example, when the voltage V is at VD, the load current command value I is IA. The controller 61 calculates the power generation current value obtained from the MPPTC of the solar cell 30. The controller 61 defines the value of the current flowing through the storage battery 40 as the storage battery current value.

The controller 61 controls the voltage and current of each part so as to satisfy the following equation (1).

Load current value+Power generation current value+Storage battery current value=0 (1)

The load current value or the storage battery current value is obtained as a command value. In the following description, since the electric power is supplied to the DC load 20 in many cases, the load current value will be described as the load current command value. Note that, when the storage battery 40 is charged, the storage battery current value is obtained as the charging current command value.

When the voltage of the DC load 20 is high, the load current command value is zero or negative. Thus, the generated current of the solar cell 30 is charged to the storage battery 40. When the solar cell 30 does not generate the electric power, the current is supplied from the storage battery 40 to the DC load 20. Further, when the solar cell 30 does not generate the electric power and the storage battery 40 is not sufficiently charged, the storage battery 40 is charged from the system power supply 50, which is connected to the DC load 20.

The controller 61 calculates the power generation current value obtained from the MPPTC of the solar cell 30. The controller 61 PWM-controls the SW element 63a (step-down transistor) of the solar cell 30 so as to reach the calculated value. At that time, if the voltage of the storage battery 40 is lower than the voltage of the DC load 20, the voltage at the connection point 60a is controlled to correspond to the voltage of the storage battery 40 so that the current having a predetermined storage battery current value flows. In this case, in regard to the DC load 20, the controller 61 PWM-controls the SW element 62b (stepping-up transistor) of the DCC 62 so that the current having a predetermined load current command value flows. Each current value is controlled based on the above equation (1).

When the total amount of power generated by the solar cell 30 is supplied to the DC load 20, the storage battery current value becomes zero, and the following equation (2) is satisfied. Therefore, the voltage at the connection point 60a can be controlled to the voltage equivalent to that of the storage battery 40.

Load current command value=(−Power generation current value) (2)

(4) Switching of Control Mode

The controller 61 executes a feedback control based on the difference between the command value and the detected value in the PWM control of the multiple SW elements. Since the capacities of the smoothing capacitors 62f, 63f, and 64f in the multiple DCCs 62, 63, and 64 are small, it is necessary to improve the responsiveness of the current control in order to follow a sudden change in the power generation amount and a sudden change in the load. Therefore, the controller 61 controls the gain for the feedback control to be a high gain over a predetermined period of time from the time of switching the control mode and to return to a low gain (normal gain) when the predetermined period of time elapses.

The controller 61 executes a constant current feedback control of the DC load 20, the solar cell 30, and the storage battery 40 based on the following equation (3).

F=Pg×(Command value−Detection value)+Sn (3)

In the equation (3), F represents the amount of feedback, Pg represents a proportional gain, and Sn represents the amount of integration.

The integrated amount Sn can be calculated by the following equation (4).

Sn=Ig×(Command value−Detection value)+Sn(n−1) (4)

In the equation (4), Ig represents the integral gain, and Sn (n−1) is the value one calculation cycle before.

The controller 61 sets the control amount for the PWM control based on the feedback amount described above. The control amount PWM for the PWM control can be calculated from the following equation (5) based on a predetermined conversion function Φ (PHI).

PWM=Φ(F) (5)

When the control mode of the DCC 63 or DCC 64 is switched due to a sudden change in the power generation amount or a sudden change in the load, high responsiveness is required. However, if the integral gain Ig and/or the proportional gain Pg is increased in order to improve the responsiveness of the electric power system 1, the control system may become unstable due to a hunting phenomenon or the like. Therefore, the controller 61 increases the integral gain Ig only when the control mode is switched.

FIG. 5 shows a change in the integral gain Ig and a change in the integrated amount Sn at the time of switching the control mode. The control mode is switched at a time point t1. This switching of the control mode exemplifies a sudden change in the power generation amount of the solar cell 30. The controller 61 usually sets the integral gain Ig based on a constant G. When the control mode is switched, the controller 61 sets the integral gain Ig larger than that at the normal time for a predetermined period of time. When the control mode is switched, the controller 61 sets the integral gain Ig as G×B for a predetermined period of time. In this case, “B” is a natural number, and “G” represents a steady-state gain set in the feedback system. The steady-state gain G is a gain at which the feedback system functions stably when there is no sudden change. “B” can be set to 10.0, for example. The predetermined period of time can be set according to the deviation. The predetermined period of time can be, for example, a period of time until the deviation reaches several tens of percent of the initial deviation immediately after the control mode is switched. The predetermined period of time can be, for example, a period of time until the deviation reaches ½ of the initial deviation immediately after the control mode is switched. The predetermined period of time may be, for example, a fixed period of time.

By setting the integral gain as described above, the feedback control that ensures responsiveness and stability is realized. In the present embodiment, the voltage fluctuation rate within ±10% at 16 msec, which is within one cycle of the AC frequency (for example, 60 Hz) of the power system 10, is realized.

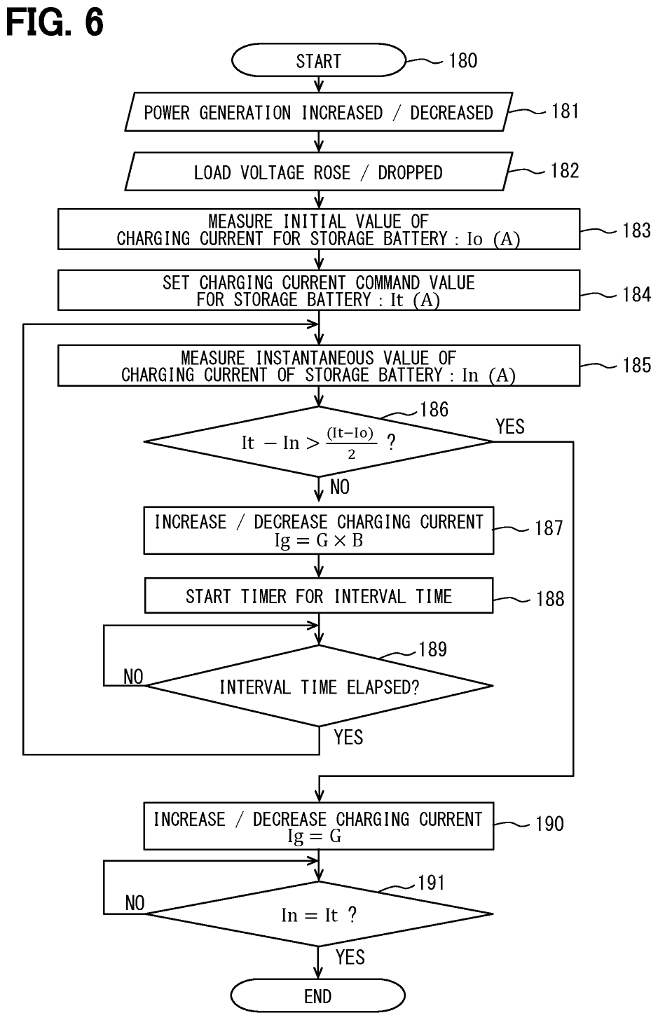

FIG. 6 shows a process 180 executed by the controller 61 for setting the integral gain Ig. Hereinafter, the case where the control mode is switched to the mode for charging the storage battery 40 will be exemplified. The steps are executed by the controller 61. Each of the steps indicates a step in the control method.

Steps 181 and 182 are steps for determining the start conditions for the following process. The steps 181 and 182 determine a sudden change in the amount of power generation and a sudden change in the load. When the sudden change in the amount of power generation or the sudden change in the load is determined in the step 181 and the step 182, the process 180 proceeds to step 183 and subsequent steps. The step 181 and the step 182 provide a determination unit for determining whether or not to change the gain.

Step 183 measures an initial value of the current value as a target to be controlled. The step 183 measures an initial value Io of the charging current of the storage battery 40. The initial value Io is used to obtain an initial deviation immediately after the control mode is switched. In step 184, the command value is set so that the total amount of current becomes zero. In the step 184, the charging current command value It for the storage battery 40 is set. In the step 184, the load current command value or the charging current command value is set so that the above-described equation (1) is satisfied in the control mode after being switched.

Step 185 measures the instantaneous value (present value) of the current value as the target to be controlled. The step 185 measures the instantaneous value In of the charging current of the storage battery 40. The instantaneous value is used to obtain the latest deviation.

Step 186 determines whether or not a predetermined period of time has elapsed. The step 186 sets the period of time for changing the integral gain Ig. The step 186 determines whether or not the following relationship (6) is satisfied. The step 186 determines whether or not the present deviation (It−In) has reached a half of the initial deviation (It−Io) immediately after switching the control mode.

It−In>(It−Io)/2 (6)

When the predetermined period of time has not elapsed in the step 186, the process proceeds to step 187. When the predetermined period of time has elapsed in the step 186, the process proceeds to step 190.

Step 187 increases or decreases the current value as the target to be controlled. At the same time, the step 187 sets the integral gain Ig. The step 187 sets the integral gain Ig based on the following equation (7).

Ig=G×B (7)

Step 188 starts a timer for an interval time for observing the current value. The interval time is set as an observation interval. Step 189 determines whether or not the interval time has elapsed. When the interval time elapses, the process returns to the step 185.

Step 190 increases or decreases the current value as the target to be controlled. At the same time, the step 190 sets the integral gain Ig. The step 190 sets the integrated gain Ig based on the following equation (8).

Ig=G (8)

Step 191 determines whether or not the current value as the target to be controlled has reached the target value. The step 191 determines whether or not the instantaneous value In of the charging current has reached the charging current command value It.

By executing the steps 181 to 191, the waveform diagram of FIG. 5 is realized. For example, in the period from the time point t1 to the time point t2, the integral gain Ig is set to G×B. During this period, the responsiveness of the feedback control is enhanced. As a result, the current value as the target to be controlled is controlled rapidly toward the target value. Eventually, when the time point t2 comes, the integral gain Ig is set to G. After the time point t2, the stability of the feedback control is enhanced. As a result, the current value to be controlled is controlled so as to converge toward the target value.

(5) Other Controls

In addition to the above control, the controller 61 provides the controls described below. The controller 61 provides an overcharge prevention unit for the smoothing capacitors 62f, 63f, and 64f connected in parallel to the DCCs 62, 63, and 64. Diodes are respectively connected to the arms (SW elements) of the DCCs 62, 63, and 64. Therefore, in each of the DCCs 62, 63, and 64, a charging circuit including the diode, the reactor, and the smoothing capacitor is formed. In a situation where only the normal stepping-up operation or the stepping-down operation is performed, the voltage at the connection point 60a is controlled, on average, to a voltage corresponding to the minimum voltage of the multiple DCCs 62, 63, and 64. However, when the SW elements 62b, 63b, and 64b for stepping up are turned off, the voltage induced in the reactor is added to the above-mentioned minimum voltage, and the voltage at the connection point 60a becomes a high voltage, though it is for a short time. For this reason, the charging circuit for the smoothing capacitor may be formed. In this case, the smoothing capacitor is thus charged. In this case, since the diode blocks the discharging, the smoothing capacitor is brought into an overvoltage state if the charging continues.

Since the solar cell 30 has a diode 63m connected in series for preventing backflow, there is no discharge circuit and an overvoltage may occur. Further, the DC load 20 also has no discharge circuit when all the loads are turned off, and an overvoltage thus may occur in the similar manner.

In order to suppress such an overvoltage of the smoothing capacitor, the controller 61 forcibly causes the discharging of the smoothing capacitor. The controller 61 forcibly turns on the stepping-down SW element for a predetermined period of time in synchronization with the turning on of the stepping-up SW element. Further, the controller 61 causes the switch elements of the discharge circuits 62g, 63g, and 64g to open. As a result, the electricity in the smoothing capacitor is discharged through the resistors of the discharge circuits 62g, 63g, and 64g. In this way, the overvoltage of the smoothing capacitor is suppressed.

According to the embodiment described above, the plurality of reactors 62r, 63r, and 64r are connected at the connection point 60a in a form of star connection. The controller 61 controls the DCCs 62, 63 and 64. As a result, power conversion between the multiple DC devices including the DC load 20, the solar cell 30, the storage battery 40, and the system power supply 50 can be realized.

### OTHER EMBODIMENTS

The disclosure in this specification and drawings is not limited to the exemplified embodiments. The disclosure encompasses the illustrated embodiments and variations thereof by those skilled in the art. For example, the disclosure is not limited to the combinations of components and/or elements shown in the embodiments. The disclosure may be implemented in various combinations.

The disclosure may have additional portions that may be added to the embodiments. The disclosure encompasses omission of components and/or elements of the embodiments. The disclosure encompasses the replacement or combination of components and/or elements between one embodiment and another. The disclosed technical scope is not limited to the description of the embodiments. The several technical ranges disclosed are indicated by the description of the claims, and should be construed to include all modifications within the meaning and range equivalent to the description of the claims.

In the embodiment described above, the DC load 20, the solar cell 30, the storage battery 40, and the system power supply 50 are connected to each other. In addition to this, a small-scale power generation device including a fuel cell, wind power generation, hydroelectric power generation, or the like may be added as one of the DC devices. Further, a storage battery of an electric vehicle such as an electric vehicle, an electric bicycle, or a senior car may be added as one of the DC devices.

In the embodiment described above, only the integral gain is adjusted as the gain of the feedback system provided by the controller 61. Alternatively or additionally, the proportional gain may be adjusted. For example, the integral gain and/or the proportional gain may be set to be larger than the steady-state value in a predetermined period of time immediately after the voltage of the solar cell 30 fluctuates, and may be returned to the steady-state value after the predetermined period of time elapses.

What is claimed is:

1. A power conversion device comprising:
a DC load;
a solar cell that converts energy of light into an electric power;
a storage battery that stores and discharges an electric power;
a first converter circuit coupled to the DC load, the first converter circuit having a switching element and a reactor;
a second converter circuit coupled to the solar cell, the second converter circuit having a switching element and a reactor;
a third converter circuit coupled to the storage battery, the third converter circuit having a switching element and a reactor;
a system power supply configured to rectify AC power supplied from a power system into DC power and to supply the rectified DC power between the DC load and the first converter circuit; and
a controller configured to control the switching elements of the first to third converter circuits,
wherein the reactors of the first to third converter circuits are connected to each other at a connection point in in a form of star connection, and
wherein the controller controls a voltage at the connection point so as to enable at least (i) an electric power supply from the solar cell to the DC load, (ii) an electric power supply from the solar cell to the storage battery, and (iii) an electric power supply from the storage battery to the DC load.

2. The power conversion device according to claim 1,
wherein the controller controls the voltage at the connection point so as to enable (iv) an electric power supply from the system power supply to the storage battery.

3. The power conversion device according to claim 1,
wherein the controller controls the second converter circuit so as to execute a maximum power point tacking control of the solar cell;
wherein a value of an electric current flowing through the solar cell is referred to as a power generation current value, a value of an electric current flowing through the storage battery is referred to as a storage battery current value, and a value of an electric current required to be supplied to the DC load is referred to as a load current command value; and
wherein the controller controls the storage battery current value so as to satisfy, at the connection point, a relationship of a sum of the load current command value and the power generation current value and the storage battery current value being zero.

4. The power conversion device according to claim 1,
wherein each of the first to third converter circuits includes a diode connected in antiparallel to a corresponding switching element, and
wherein the controller controls the switching elements of the first to third converter circuit to control the voltage at the connection point to be equal to a lowest one of a voltage of the solar cell and a voltage of the storage battery, or to the lowest one plus a voltage drop in the diode.

5. The power conversion device according to claim 1,
wherein the controller includes a feedback system to feedback control the switching element of the third converter circuit, and
wherein in response to a sudden change including a sudden decrease in an amount of power generated by the solar cell or a sudden change in the DC load, the controller sets a gain of the feedback system to a reinforcement gain larger than a predetermined value for a predetermined period of time from the sudden change, and returns the gain to a gain smaller than the reinforcement gain after the predetermined period of time elapses.

6. The power conversion device according to claim 5,
wherein the controller keeps the reinforcement gain until a time point at which a value of an electric current of the storage battery reaches a predetermined current value after the sudden change.

7. The power conversion device according to claim 5,
wherein the controller returns the gain of the feedback system from the reinforcement gain to a gain of a steady state after the predetermined period of time elapses.

8. The power conversion device according to claim 5,
wherein the reinforcement gain is set to a value that enhances charging and discharging responsiveness of the storage battery and improves a rise of the electric current of the storage battery.

9. The power conversion device according to claim 1,
wherein the switching element of the first converter circuit includes a stepping-down switching element for a stepping-down operation and a stepping-up switching element for a stepping-up operation,
wherein the first converter circuit further includes a smoothing capacitor, and
wherein, when a voltage of the solar cell and a voltage of the storage battery are both higher than a voltage of the DC load and when the electric power is supplied from the battery cell to the storage battery, the controller closes a discharge circuit of the smoothing capacitor to restrict an overvoltage due to charging of the smoothing capacitor.

10. The power conversion device according to claim 9,
wherein the controller closes the stepping-down switching element with a pulse width determined by the voltage of the smoothing capacitor so as to provide the discharge circuit.
